(19) United States
(12) Patent Application Publication
(10) Pub. No.: US 2010/0118940 A1
(43) Pub. Date: May 13, 2010

(54) ADAPTIVE REFERENCE PICTURE DATA GENERATION FOR INTRA PREDICTION

(76) Inventors: Peng Yin, West Windsor, NJ (US); Oscar Divorra Escoda, Princeton, NJ (US); Congxia Dai, Morgantown, WV (US)

Correspondence Address: Robert D. Shedd, Patent Operations;THOMSON Licensing LLC, P.O. Box 5312, Princeton, NJ, 08543-5312, US

(21) Appl. No.: 12/450,585

(22) PCT Filed: Jun. 25, 2007
(86) PCT No.: PCT/US2007/014752

§ 371 Date: Oct. 1, 2009

Related U.S. Application Data
(60) Provisional application No. 60/925,351, filed on Apr. 18, 2007.

(51) Int. Cl. H04N 7/32

(52) U.S. Cl. 375/240.12; 375/240.29

(57) ABSTRACT

A device incorporates an H.264 compatible video encoder for providing compressed, or encoded, video data. The H.264 encoder comprises a buffer for storing previously coded macroblocks of a current picture being encoded; and a processor for generating adaptive reference picture data from the previously coded macroblocks of the current picture; wherein the adaptive reference picture data is for use in predicting uncoded macroblocks of the current picture.

### CROSS-REFERENCE TO RELATED APPLICATIONS

This application claims the benefit of U.S. Provisional Application No. 60/925,351, filed Apr. 19, 2007.

### BACKGROUND OF THE INVENTION

The present invention generally relates to communications systems and, more particularly, to video coding and decoding.

In typical video compression systems and standards, such as MPEG-2 and JVT/H.264/MPEG AVC (e.g., see ITU-T Rec. H.264, “Advanced video coding for generic audiovisual services”, 2005), encoders and decoders generally rely on intra frame prediction and inter frame prediction in order to achieve compression. With regard to intra frame prediction, various methods have been proposed to improve intra frame prediction. For example, displaced intra prediction (DIP) and template matching (TM) have achieved good coding efficiency for texture prediction. The similarity between these two approaches is that they both search the previously encoded intra regions of the current picture being coded (i.e., they use the current picture as a reference) and find the best prediction according to some coding cost, by performing, for example, region matching and/or auto-regressive template matching.

### SUMMARY OF THE INVENTION

We have observed that both displaced intra prediction (DIP) and template matching (TM) encounter similar problems that degrade coding performance and/or visual quality. Specifically, the reference picture data from previously coded intra regions of the current picture may contain some blocky or other coding artifact, which degrades coding performance and/or visual quality. However, we have also realized that it is possible to address the above-described coding performance problems with regard to intra coding. In particular, and in accordance with the principles of the invention, a method for encoding comprises the steps of generating adaptive reference picture data from previously coded macroblocks of a current picture; and predicting uncoded macroblocks of the current picture from the adaptive reference picture data.

In an embodiment of the invention, a device incorporates an H.264 compatible video encoder for providing compressed, or encoded, video data. The H.264 encoder comprises a buffer for storing previously coded macroblocks of a current picture being encoded; and a processor for generating adaptive reference picture data from the previously coded macroblocks of the current picture; wherein the adaptive reference picture data is for use in predicting uncoded macroblocks of the current picture.

In another embodiment of the invention, a device incorporates an H.264 compatible video decoder for providing video data. The H.264 decoder comprises a buffer for storing previously coded macroblocks of a current picture being decoded; and a processor for generating adaptive reference picture data from the previously coded macroblocks of the current picture; wherein the adaptive reference picture data is for use in decoding macroblocks of the current picture.

In view of the above, and as will be apparent from reading the detailed description, other embodiments and features are also possible and fall within the principles of the invention.

### BRIEF DESCRIPTION OF THE DRAWINGS

FIGS. 1 to 8 illustrate prior art video encoding and decoding for intra frame prediction using DIP or TM;

FIG. 9 shows an illustrative device in accordance with the principles of the invention;

FIG. 10 shows an illustrative block diagram of an H.264 encoder in accordance with the principles of the invention;

FIG. 11 shows another illustrative block diagram of a video encoder in accordance with the principles of the invention;

FIG. 12 shows Table One illustrating the different types of processing in accordance with the principles of the invention;

FIG. 13 shows Table Two illustrating a high-level syntax for use in the device of FIG. 9 or the H.264 encoder of FIG. 10;

FIGS. 14 and 15 show other illustrative block diagrams of a video encoder in accordance with the principles of the invention;

FIG. 16 shows an illustrative flow chart for use in a video encoder in accordance with the principles of the invention;

FIG. 17 shows another illustrative device in accordance with the principles of the invention;

FIGS. 18 and 19 show illustrative block diagrams of a video decoder in accordance with the principles of the invention;

FIG. 20 shows an illustrative flow chart for use in a video decoder in accordance with the principles of the invention; and

FIGS. 21 to 26 show other illustrative embodiments in accordance with the principles of the invention.

### DETAILED DESCRIPTION

Other than the inventive concept, the elements shown in the figures are well known and will not be described in detail. Also, familiarity with video broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC) is assumed. Likewise, other than the inventive concept, transmission concepts such as eight-level vestigial sideband (8-VSB), Quadrature Amplitude Modulation (QAM), and receiver components such as a radio-frequency (RF) front-end, or receiver section, such as a low noise block, tuners, demodulators, correlators, leak integrators and squarers is assumed. Similarly, other than the inventive concept, formatting and encoding methods (such as Moving Picture Expert Group (MPEG)-2 Systems Standard (ISO/IEC 13818-1)) and, in particular, H.264: International Telecommunication Union, “Recommendation ITU-T H.264: Advanced Video Coding for Generic Audiovisual Services,” ITU-T, 2005, for generating bit streams are well-known and not described herein. In this regard, it should be noted that only that portion of the inventive concept that is different from known video encoding is described below and shown in the figures. As such, H.264 video encoding concepts of pictures, frames, fields, macroblocks, luma, chroma, Intra frame prediction, Inter frame prediction, etc., is assumed and not described herein. For example, other than the inventive concept, intra frame prediction techniques such as spatial direction prediction, and those currently proposed for inclusion in extensions of H.264 such as displaced intra prediction (DIP) and template matching (TM) techniques, are known and not described in detail herein. It should also be noted that the inventive concept may be implemented using conventional programming techniques, which, as such, will also not be described herein. Finally, like-numbers on the figures represent similar elements.

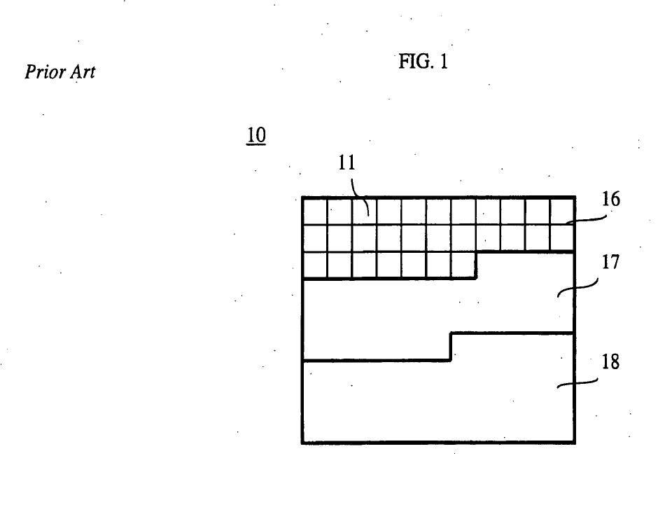

Turning briefly to FIGS. 1-8, some general background information is presented. Generally, and as known in the art, a picture, or frame, of video is partitioned into a number of macroblocks (MBs). In addition, the MBs are organized into a number of slices. This is illustrated in FIG. 1 for a picture 10, which comprises three slices 16, 17, 18; where each slice includes a number of MBs as represented by MB 11. As noted above, for intra frame prediction, the techniques of spatial direction prediction, displaced intra prediction (DIP) and template matching (TM) can be used to process the MBs of picture 10.

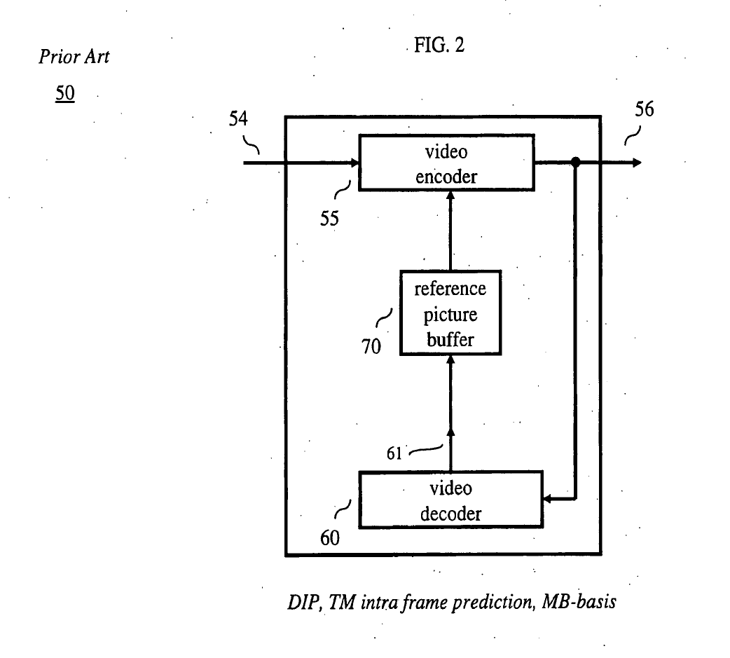

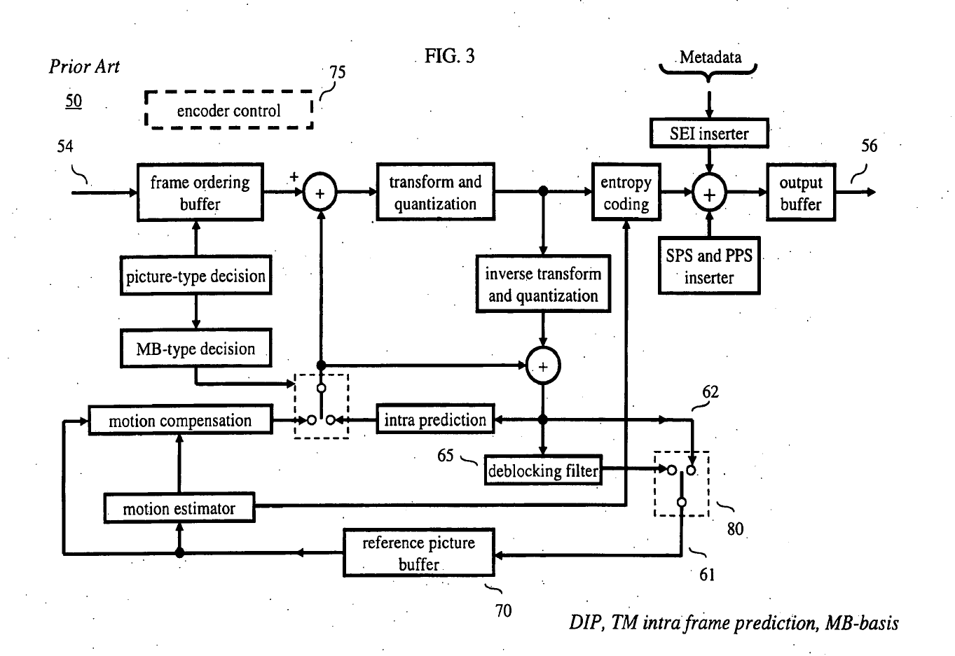

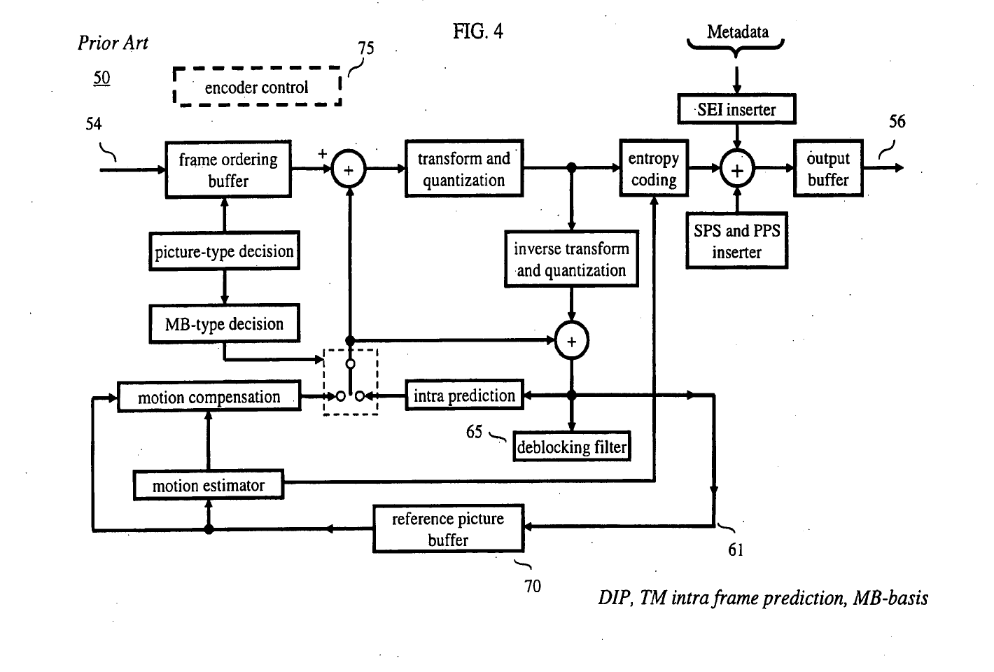

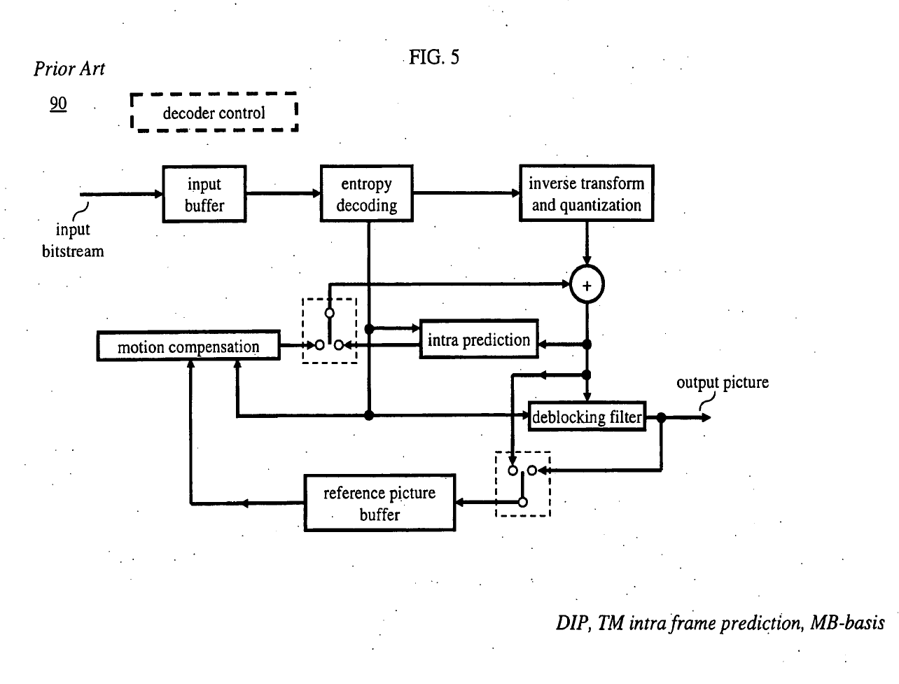

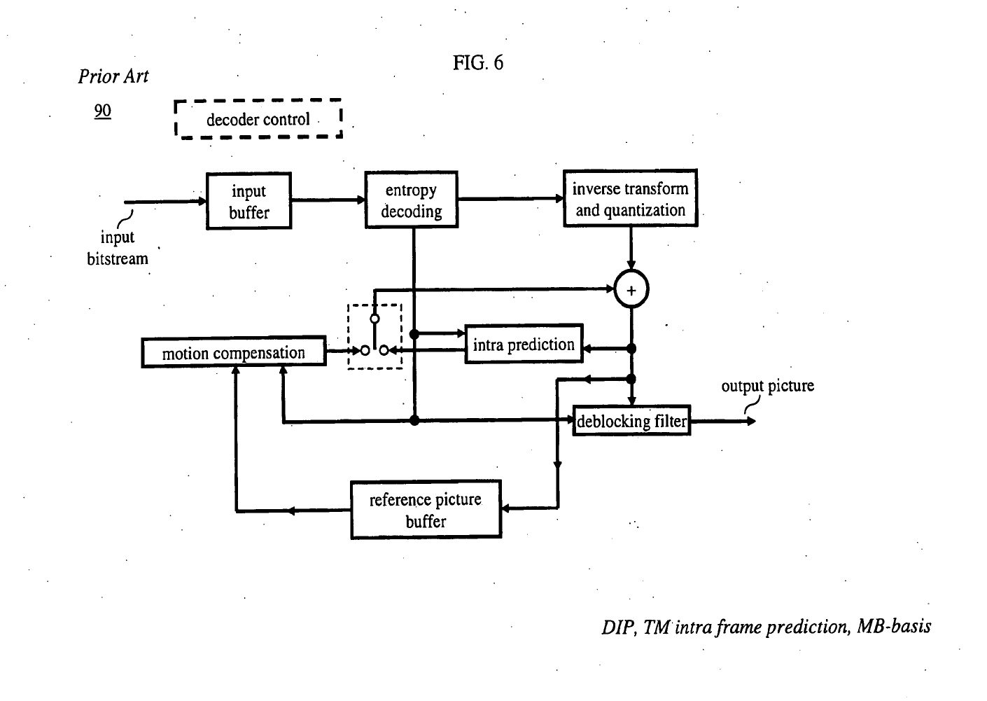

A high-level representation of a prior art H.264-based encoder 50 is shown in FIG. 2 for use in intra frame prediction using either DIP or TM proposed extensions to H.264 (hereafter simply referred to as encoder 50). As such, other modes supported by an H.264 encoder are not described herein. An input video signal 54 is applied to encoder 50, which provides an encoded, or compressed, output video signal 56. It should be observed that encoder 50 comprises video encoder 55, video decoder 60, and reference picture buffer 70. In particular, encoder 50 duplicates the decoder processing so that both encoder 50 and a corresponding H.264-based decoder (not shown in FIG. 2) will generate identical predictions for subsequent data. Thus, encoder 50 also decodes (decompresses) the encoded output video signal 56 and provides decoded video signal 61. As shown in FIG. 2, the decoded video signal 61 is stored in reference picture buffer 70 for use in the prediction of subsequent encoded MBs in either the DIP or TM intra frame prediction techniques. It should be noted that either DIP or TM operate on a MB-basis, i.e., reference picture buffer 70 stores a MB, which is used for prediction of the subsequent encoded MBs. For completeness, a more detailed block diagram of prior art encoder 50 is shown in FIG. 3, the elements and operation of which are known in the art and are not described further herein. It should be noted that encoder control 75 is shown in dotted line form to represent control of all elements in FIG. 3 in a simplified fashion (versus showing individual control/signaling paths between encoder control 75 and the other elements of FIG. 3). In this regard, it should be noted that during DIP or TM intra frame prediction, each decoded MB is provided via signaling path 62 to reference picture buffer 70 via switch 80 (which is under the control of encoder control 75). In other words, each previously coded MB is not processed by deblocking filter 65. A more simplified view of the data flow in a encoder 50 when performing DIP or TM intra frame prediction is shown in FIG. 4. Similarly, a corresponding prior art H.264-based decoder 90 is shown in FIG. 5 for use in intra frame prediction using either DIP or TM proposed extensions to H.264. Again, a simplified form is shown in FIG. 6 when H.264-based decoder 90 is performing DIP or TM intra frame prediction.

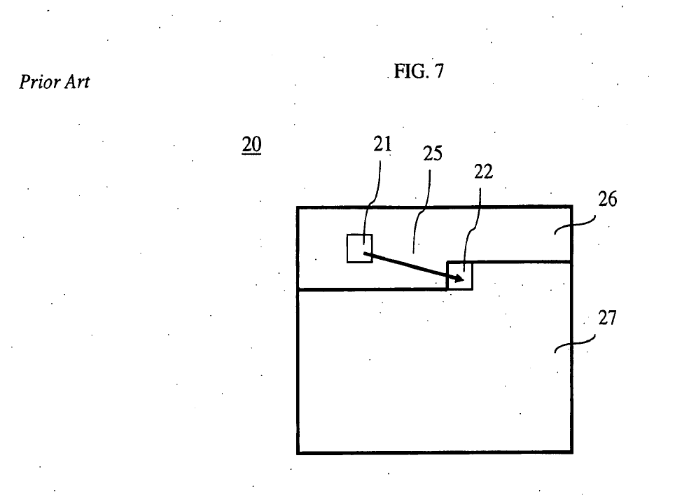

As noted above, an extension of an H.264 encoder may perform DIP or TM intra frame prediction. DIP intra frame prediction is illustrated in FIG. 7 for a picture 20 at a point in time, T, in the intra frame encoding process (e.g., see, S.-L. Yu and C. Chrysafis, “New Intra Prediction using Intra-Macroblock Motion Compensation”, JVT meeting Fairfax, doc JVT-C151, May 2002; and J. Balle, and M. Wien, “Extended Texture Prediction for H.264 Intra Coding”, VCEG-AE11.doc, January 2007). As noted above, DIP is implemented on a MB basis. At time T, region 26 of picture 20 has been encoded, i.e., region 26 is an intra coded region; and region 27 of picture 20 is not yet encoded, i.e., uncoded. In DIP, a previously encoded MB is referenced by a displacement vector to predict the current MB. This is illustrated in FIG. 7, where previously encoded MB 21 is referenced by displacement vector (arrow) 25 to predict current MB 22. The displacement vectors are encoded differentially using a prediction by the median of the neighboring blocks, in analogy to the inter motion vectors of H.264.

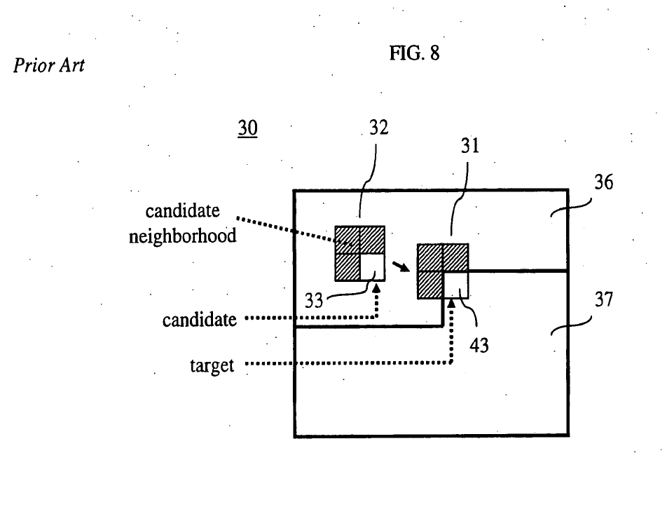

In a similar fashion, TM is illustrated in FIG. 8 for a picture 30 at a point in time, T, in the intra frame encoding process (e.g., see, T. K. Tan, C. S. Boon, and Y. Suzuki, “Intra Prediction by Template Matching”, ICIP 2006; and J. Balle, and M. Wien, “Extended Texture Prediction for H.264 Intra Coding”, VCEG-AE11.doc, January 2007). Like DIP, TM is implemented on a MB basis. At time T, region 36 of picture 30 has been encoded, i.e., region 36 is an intra coded region; and region 37 of picture 30 is not yet encoded, i.e., uncoded. In TM, self-similarities of image regions are exploited for prediction. In particular, the TM algorithm recursively determines the value of the current pixel (or target) by searching the intra coded region for a similar neighborhood of pixels. This is illustrated in FIG. 8, where the current MB, 43, the target, has an associated neighborhood (or template), 31, of surrounding coded MBs. Intra coded region 36 is then searched to identify a similar candidate neighborhood, here represented by neighborhood 32. Once a similar neighborhood has been located, then, as illustrated in FIG. 8, MB 33 of the candidate neighborhood is used as the candidate MB for predicting the target, MB 43.

As noted earlier, both DIP and TM have achieved good coding efficiency for texture prediction. The similarity between these two approaches is that they both search the previously encoded intra regions of the current picture being coded (i.e., they use the current picture as a reference) and find the best prediction according to some coding cost, by performing, for example, region matching and/or auto-regressive template matching. Unfortunately, both DIP and TM encounter similar problems that degrade coding performance and/or visual quality. Specifically, the reference picture data stored in reference picture buffer 70 from previously coded intra regions of the current picture (e.g., intra region 26 of FIG. 7 or intra region 36 of FIG. 8) may contain some blocky or other coding artifact, which degrades coding performance and/or visual quality. However, it is possible to address the above-described coding performance problems with regard to intra coding. In particular, and in accordance with the principles of the invention, a method for encoding comprises the steps of generating adaptive reference picture data from previously coded macroblocks of a current picture; and predicting uncoded macroblocks of the current picture from the adaptive reference picture data.

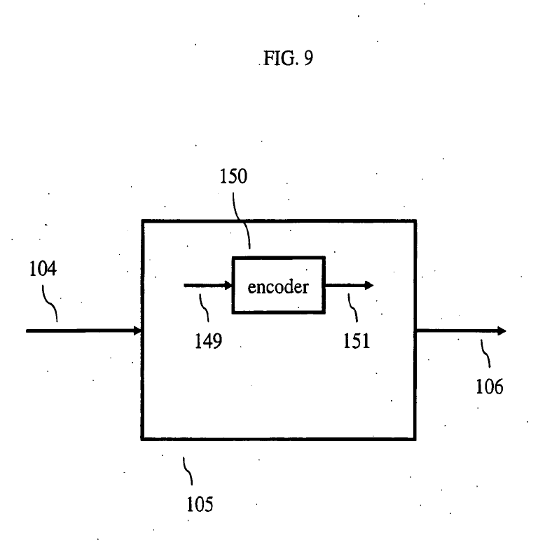

An illustrative embodiment of a device 105 in accordance with the principles of the invention is shown in FIG. 9. Device 105 is representative of any processor-based platform, e.g., a PC, a server, a personal digital assistant (PDA), a cellular telephone, etc. In this regard, device 105 includes one or more processors with associated memory (not shown). Device 105 includes an extended H.264 encoder 150 modified in accordance with the inventive concept (hereafter referred to as encoder 150). Other than the inventive concept, it is assumed that encoder 150 conforms to ITU-T H.264 (noted above) and also supports the above-mentioned intra frame prediction techniques of displaced intra prediction (DIP) and template matching (TM) proposed extensions. Encoder 150 receives a video signal 149 (which is, e.g., derived from input signal 104) and provides an encoded video signal 151. The latter may be included as a part of an output signal 106, which represents an output signal from device 105 to, e.g., another device, or network (wired, wireless, etc.). It should be noted that although FIG. 9 shows that encoder 150 is a part of device 105, the invention is not so limited and encoder 150 may be external to device 105, e.g., physically adjacent, or deployed elsewhere in a network (cable, Internet, cellular, etc.) such that device 105 can use encoder 150 for providing an encoded video signal. For the purposes of this example only, it is assumed that video signal 149 is a real-time video signal conforming to a CIF (Common Intermediate Format) video format.

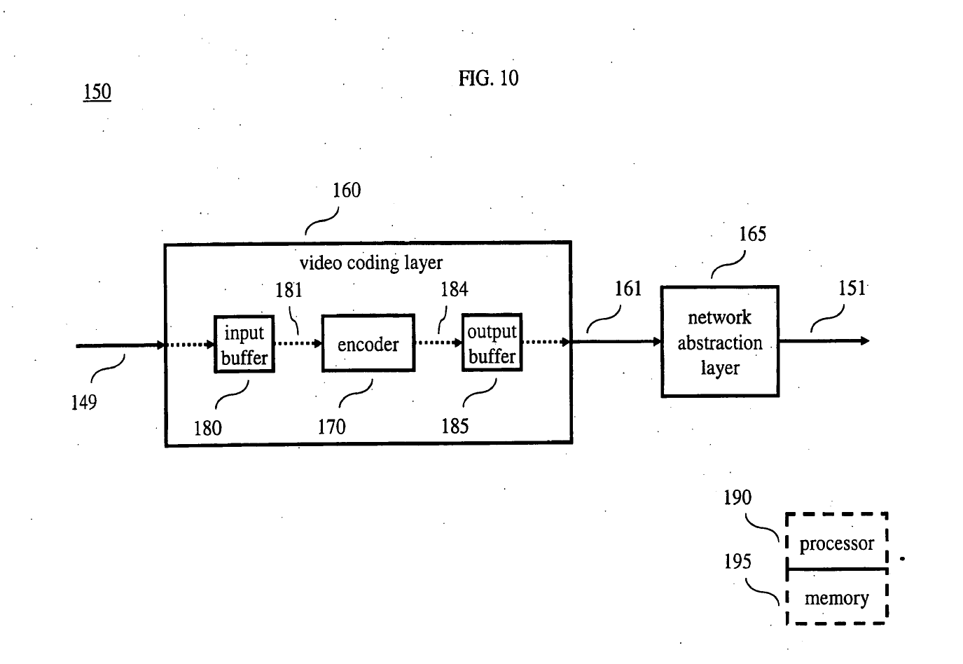

An illustrative block diagram of encoder 150 is shown in FIG. 10. Illustratively, encoder 150 is a software-based video encoder as represented by processor 190 and memory 195 shown in the form of dashed boxes in FIG. 10. In this context, computer programs, or software are stored in memory 195 for execution by processor 190. The latter is representative of one or more stored-program control processors and does not have to be dedicated to the video encoder function, e.g., processor 190 may also control other functions of device 105. Memory 195 is representative of any storage device, e.g., random-access memory (RAM), read-only memory (ROM), etc.; may be internal and/or external to encoder 150; and is volatile and/or non-volatile as necessary. Other than the inventive concept, encoder 150 has two layers as represented by video coding layer 160 and network abstraction layer 165 as known in the art. In this regard, video coding layer 160 of encoder 150 incorporates the inventive concept (described further below). Video coding layer 160 provides an encoded signal 161, which comprises the video coded data as known in the art, e.g., video sequence, picture, slice and MB. Video coding layer. 160 comprises an input buffer 180, an encoder 170 and an output buffer 185. The input buffer 180 stores video data from video signal 149 for processing by encoder 170. Other than the inventive concept, described below, encoder 170 compresses the video data in accordance with H.264 as described above, and provides compressed video data to output buffer 185. The latter provides the compressed video data as encoded signal 161 to the network abstraction layer 165, which formats the encoded signal 161 in a manner that is appropriate for conveyance on a variety of communications channels or storage channels to provide H.264 video encoded signal 151. For example, network abstraction layer 165 facilitates the ability to map encoded signal 161 to transport layers such as RTP (real-time protocol)/IP (Internet Protocol), file formats (e.g., ISO MP4 (MPEG-4 standard (ISO 14496-14)) for storage and Multimedia Messaging (MMS)), H.32X for wireline and wireless conversational services), MPEG-2 systems for broadcasting services, etc.

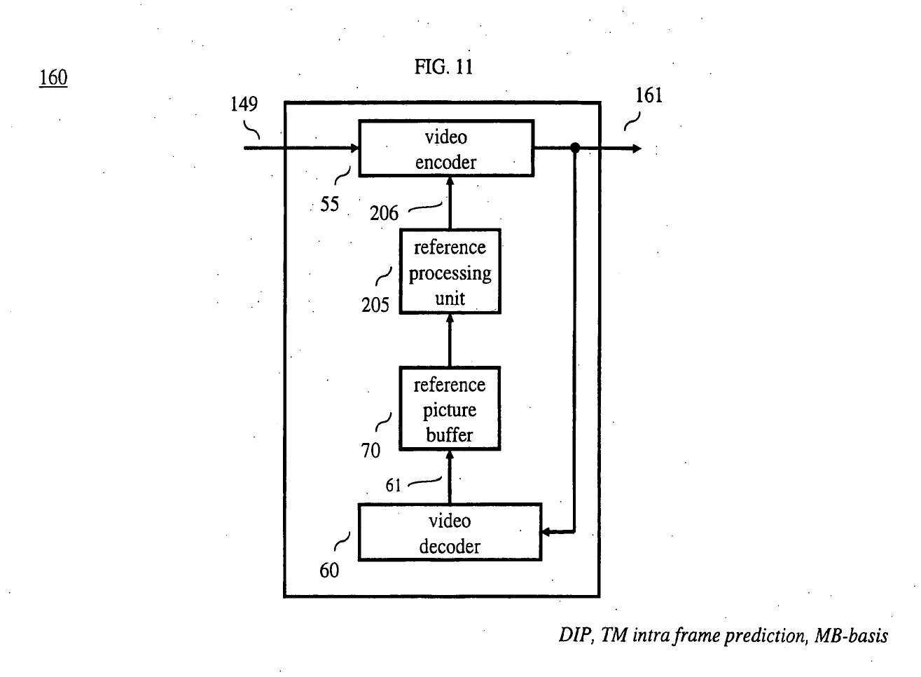

An illustrative block diagram of video encoder 160 for use in intra frame Prediction in accordance with the principles of the invention is shown in FIG. 11. For the purposes of this example, it is assumed that video encoder 160 performs either DIP or TM intra frame prediction for a current picture. As such, other modes supported by video coding layer 160 in accordance with the H.264 standard are not described herein. Video coding layer 160 comprises video encoder 55, video decoder 60, reference picture buffer 70 and reference processing unit 205. An input video signal 149, representing the current picture, is applied to video encoder 55, which provides an encoded, or compressed, output signal 161. The encoded output signal 161 is also applied to video decoder 60, which provides decoded video signal 61. The latter represents a previously coded MB of the current picture and is stored in reference picture buffer 70. In accordance with the principles of the invention, reference processing unit 205 generates adaptive reference picture data (signal 206) from the previously coded MB picture data stored in reference picture buffer 70 for the picture currently being coded (i.e., the current picture). It is this adaptive reference picture data that is now used in the prediction of subsequent encoded MBs in either the DIP or TM intra frame prediction techniques for the current picture. Thus, reference processing unit 205 can filter the previously coded MB picture data to remove or mitigate any blocky or other coding artifacts.

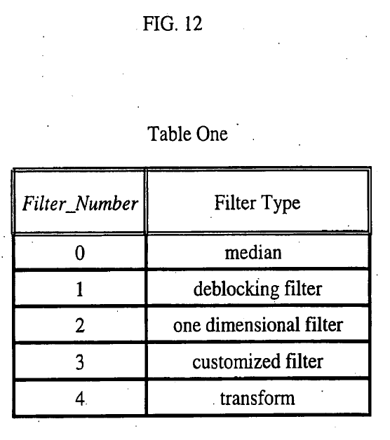

Indeed, reference processing unit 205 can apply any one of a number of filters to generate different adaptive reference picture data. This is illustrated in Table One of FIG. 12. Table One illustrates a list of different filtering or processing techniques that reference processing unit 205 can use to generate the adaptive reference picture data. Table One illustrates six different processing techniques, referred to herein generally as “filter types”. In this example, each filter type is associated with a Filter_Number parameter. For example, if the value of the Filter_Number parameter is zero, then reference processing unit 205 uses a median-type filter to process the previously coded MB picture data stored in reference picture buffer 70. Similarly, if the value of the Filter_Number parameter is one, then reference processing unit 205 uses a deblocking filter to process the previously coded MB picture data stored in reference picture buffer 70. This deblocking filter is similar to deblocking 65 of FIG. 3 as specified in H.264. As indicated in Table One, a customized filter type can also be defined.

It should be noted that Table One is just an example, and reference processing unit 205 can apply any one of a filter, transformation, warping, or projection on the data stored in reference picture buffer 70 in accordance with the principles of the invention. Indeed, the filters used to generate the adaptive reference picture data can be any spatial filter, median filter, Wiener filtering, Geometric Mean, Least Square etc. In fact, one can use any linear and nonlinear filter that could be used to remove the coding artifacts of the current (reference) picture. It is also possible to consider temporal methods, such as temporal filtering of previously coded pictures. Likewise, warping can be an affine transform or other linear and nonlinear transform which allows a better match of the currently to be coded intra block.

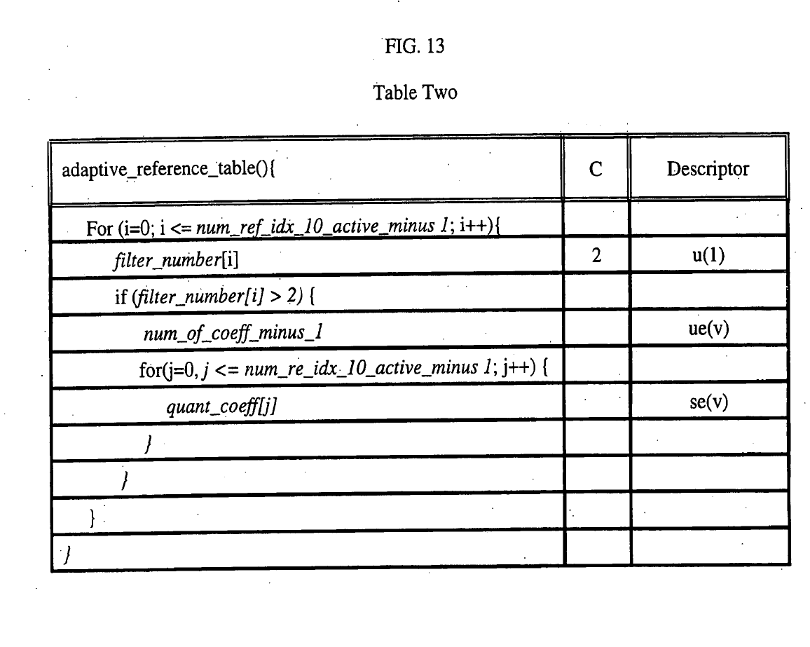

If reference processing unit 205 uses more than one type of filter, then a reference index is also used to associate the filter type with particular adaptive reference picture data produced by reference processing unit 205. Turning now to FIG. 13, an illustrative reference list is shown in Table Two in accordance with the principles of the invention. Table Two represents an illustrative syntax for conveying information to an H.264 decoder. This information is conveyed in the high level syntax of H.264, e.g.; a sequence parameter set, a picture parameter set, a slice header, etc. For example, see section 7.2 of the above-mentioned H.264 standard. In Table Two, the parameter filter_number [i] specifies the filter type for i^{th} reference; the parameter num_of_coeff_minus_{—}1 plus 1 specifies the number of coefficients; and the parameter quant_coeff [j] specifies the quantized value of the j^{th} coefficient. The Descriptors u(1), ue(v) and se(v) are defined as in H.264 (e.g., see section 7.2). For example, u(1) is an unsigned integer of 1 bit; ue(v) is an unsigned integer Exp-Golomb-coded syntax element with the left bit first, where the parsing process for this descriptor is specified in section 9.1 of the H.264 standard; and se(v) is a signed integer Exp-Golomb-coded syntax element with the left bit first, where the parsing process for this descriptor is specified in section 9.1 of the H.264 standard.

As described above, an encoder or other device may apply multiple different filters to a reference picture data from the current picture being encoded. The encoder can use one or more of the filter types for performing intra frame prediction of the current picture. For example, the encoder may create a first reference for the current picture that uses a median filter. The encoder may also create a second reference that uses a geometric-mean filter, and create a third reference that uses a Wiener filter, etc. In this way, an implementation may provide an encoder that adaptively determines which reference (which filter) to use for any given MB, or region, of the current picture. The encoder may, for example, use a median filter reference for the first half of the current picture, and use a geometric-mean filter reference for the second half of the current picture.

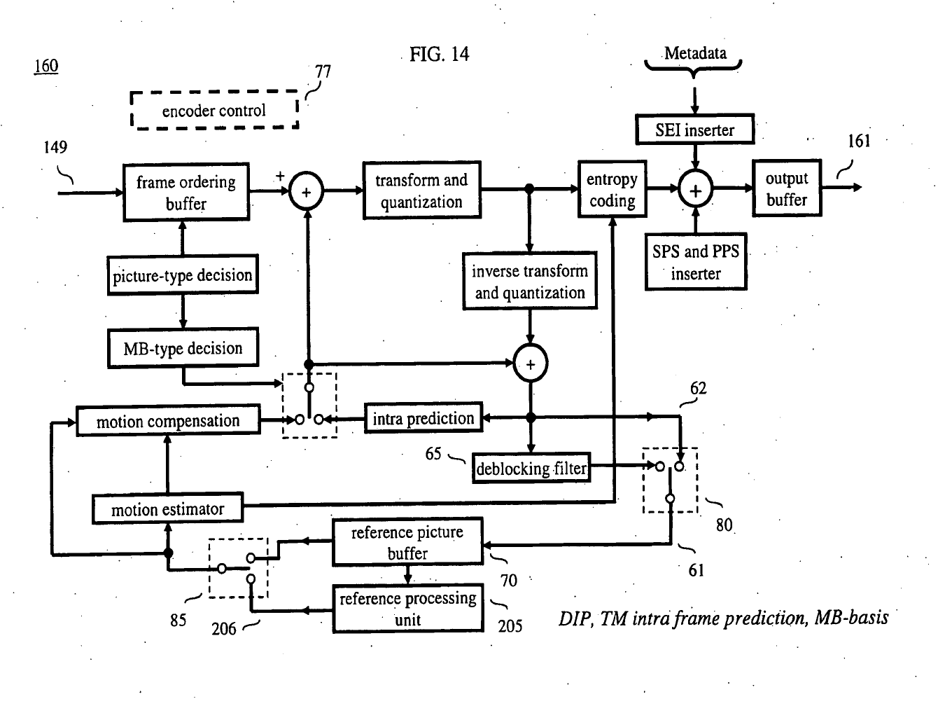

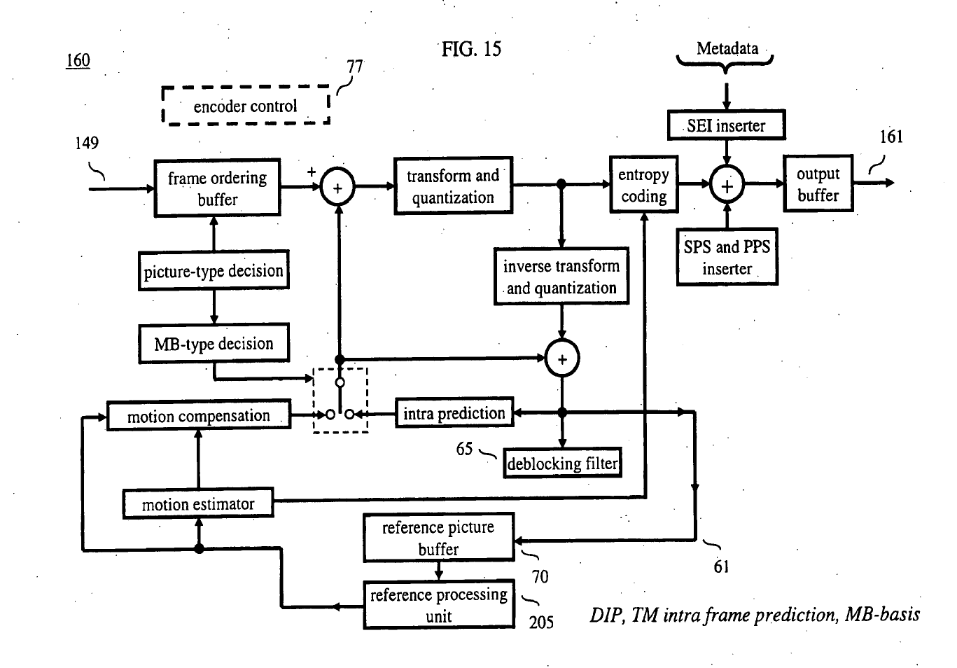

For completeness, a more detailed block diagram of video coding layer 160 in accordance with the principles of the invention is shown in FIG. 14. Other than the inventive, the elements shown in FIG. 14 represent an H.264-based encoder as known in the art and are not described further herein. It should be noted that encoder control 77 is shown in dotted line form to represent control of all elements in FIG. 14 in a simplified fashion (versus showing individual control/signaling paths between encoder control 77 and the other elements of FIG. 14). In this regard, it should be noted that during DIP or TM intra frame prediction, each decoded MB is provided via signaling path 62 to reference picture buffer 70 via switch 80 (which is under the control of encoder control 77). In accordance with the principles of the invention, encoder control 77 additionally controls switch 85 for providing adaptive reference picture data 206 and, if more than one processing technique is available, the selection of the Filter Type for use by reference processing unit 205. A more simplified view of the data flow in video coding layer 160 when performing DIP or TM intra frame prediction in accordance with the principles of the invention is shown in FIG. 15.

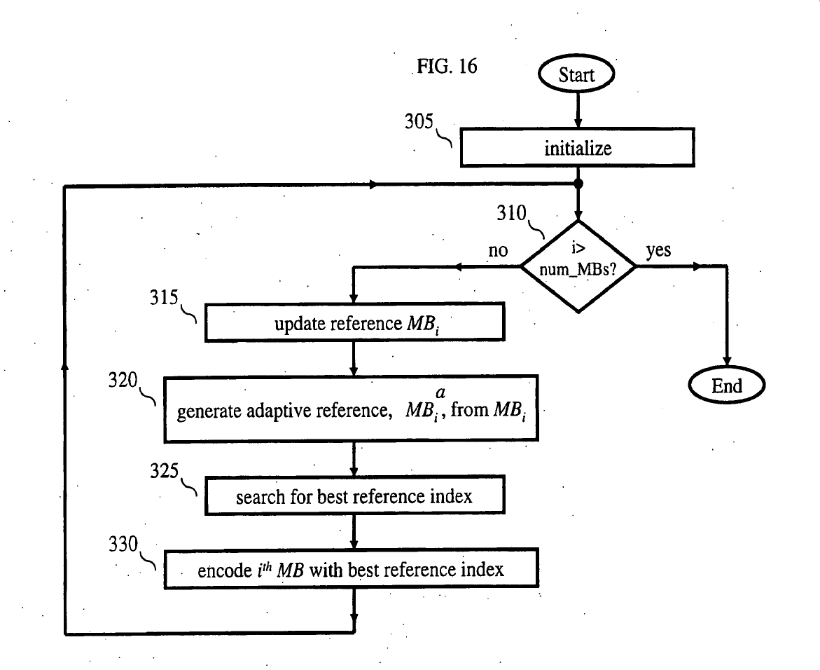

Referring now to FIG. 16, an illustrative flow chart in accordance with the principles of the invention is shown for use in video coding layer 160 of FIG. 10 for performing intra frame prediction of at least one picture, or frame, of video signal 149 of FIG. 10. Generally, and as known in the art, the current picture (not shown) is partitioned into a number of macroblocks (MBs). In this example, it is assumed that displaced intra prediction (DIP) is used for intra frame prediction. Similar processing is performed for TM in accordance with the principles of the invention and, as such, is not described herein. As noted above, DIP is implemented on a macroblock basis. In particular, in step 305, initialization occurs for the intra frame prediction of the current picture. For example, the number of MBs, N, for the current picture is determined, a loop parameter, i, is set equal to 0, (where 0≦i<N) and a reference picture buffer is initialized. In step 310, the value of the loop parameter, i, is checked to determine if all of the MBs have been processed, in which case the routine exits, or ends. Otherwise, for each MB steps 315 to 330 are executed to perform intra frame prediction for the current picture. In step 315, the reference picture buffer is updated with data from the i^{th}−1 coded MB. For example, the data stored in the reference picture buffer represents the uncoded pixels from the i^{th}−1 DIP coded MB. In step 330, and in accordance with the principles of the invention, adaptive reference picture data, MBᵢ₋₁^{α}, is generated from the i^{th}−1 coded MB, as described above (e.g., see reference processing unit 205 of FIG. 11 and Table One of FIG. 12). In steps 325 and 330, DIP is performed and searches for the best reference index (step 325) using the adaptive reference picture data, MBᵢ₋₁^{α}, and, once found, encodes the i^{th} MB with the best reference index (step 330).

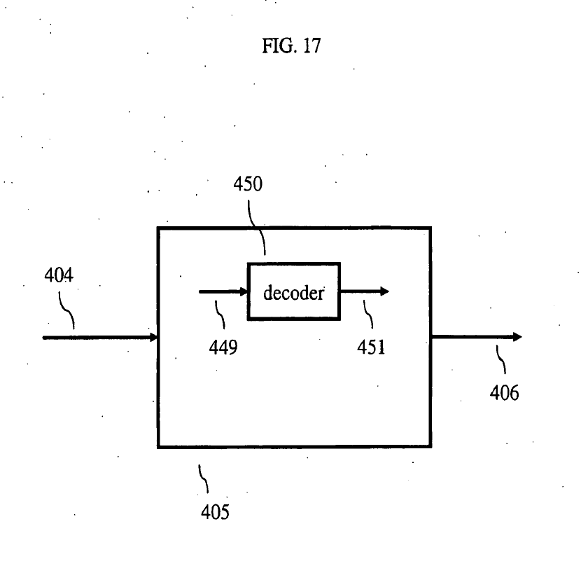

Turning now to FIG. 17, another illustrative embodiment of a device 405 in accordance with the principles of the invention is shown. Device 405 is representative of any processor-based platform, e.g., a PC, a server, a personal digital assistant (PDA), a cellular telephone, etc. In this regard, device 405 includes one or more processors with associated memory (not shown). Device 405 includes extended H.264 decoder 450 modified in accordance with the inventive concept (hereafter referred to as decoder 450). Other than the inventive concept, it is assumed that decoder 450 conforms to ITU-T H.264 (noted above) and also supports the above-mentioned intra frame prediction techniques of displaced intra prediction (DIP) and template matching (TM) proposed extensions. Decoder 450 receives an encoded video signal 449 (which is, e.g., derived from input signal 404) and provides a decoded video signal 451. The latter may be included as a part of an output signal 406, which represents an output signal from device 405 to, e.g., another device, or network (wired, wireless, etc.). It should be noted that although FIG. 17 shows that decoder 450 is a part of device 405, the invention is not so limited and decoder 450 may be external to device 405, e.g., physically adjacent, or deployed elsewhere in a network (cable, Internet, cellular, etc.) such that device 405 can use decoder 450 for providing an decoded video signal.

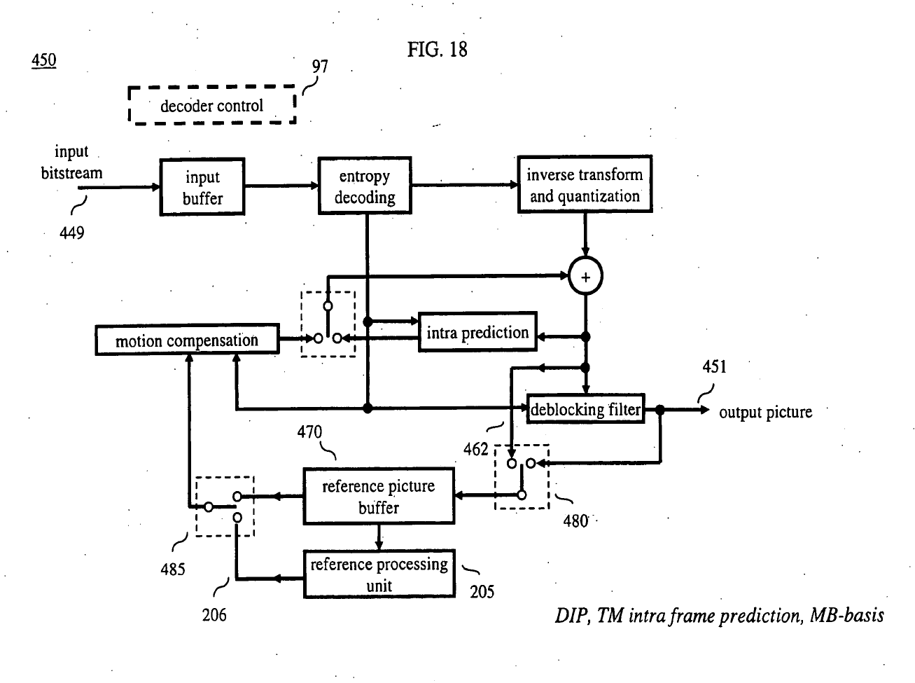

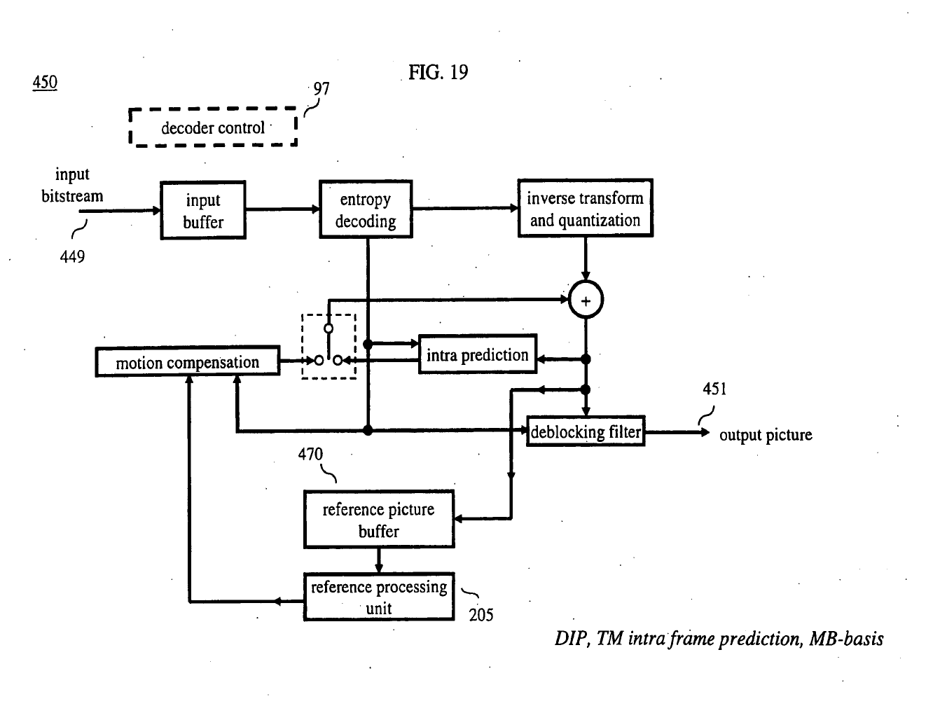

For completeness, a more detailed block diagram of decoder 450 in accordance with the principles of the invention is shown in FIG. 18. Other than the inventive, the elements shown in FIG. 18 represent an H.264-based decoder as known in the art and are not described further herein. Decoder 450 performs in a complementary fashion to that of video coding layer 160, described above. Decoder 450 receives an input bitstream 449 and recovers therefrom an output picture 451. It should be noted that decoder control 97 is shown in dotted line form to represent control of all elements in FIG. 18 in a simplified fashion (versus showing individual control/signaling paths between decoder control 97 and the other elements of FIG. 18). In this regard, it should be noted that during DIP or TM intra frame prediction, each decoded MB is provided via signaling path 462 to reference picture buffer 70 via switch 80 (which is under the control of decoder control 97). In accordance with the principles of the invention, decoder control 97 additionally controls switch 485 for providing adaptive reference picture data 206 and, if more than one processing technique is available, the selection of the Filter Type for use by reference processing unit 205. It should be recalled that if more than one filter type exists, decoder 450 retrieves the reference list from, e.g., a received slice header, to determine the filter type. A more simplified view of the data flow in decoder 450 when performing DIP or TM intra frame prediction in accordance with the principles of the invention is shown in FIG. 19.

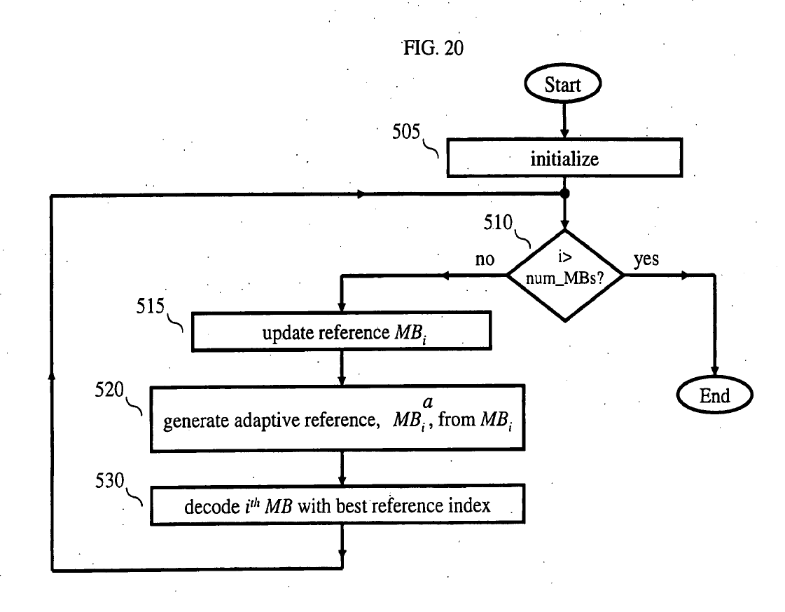

Referring now to FIG. 20, an illustrative flow chart in accordance with the principles of the invention is shown for use in decoder 450 of FIG. 17. The flow chart of FIG. 20 is complementary to that show in FIG. 16 for encoding the video signal. Again, it is assumed that displaced intra prediction (DIP) is used for intra frame prediction. Similar processing is performed for TM in accordance with the principles of the invention and, as such, is not described herein. As noted above, DIP is implemented on a macroblock basis. In particular, in step 505, initialization occurs for the intra frame prediction of the current picture. For example, the number of MBs, N, for the current picture is determined, a loop parameter, i, is set equal to 0, (where 023 i<N) and a reference picture buffer is initialized. In step 510, the value of the loop parameter, i, is checked to determine if all of the MBs have been processed, in which case the routine exits, or ends. Otherwise, for each MB steps 515 to 530 are executed to perform intra frame prediction for the current picture. In step 515, the reference picture buffer is updated with data from the i^{th}−1 coded MB. For example, the data stored in the reference picture buffer represents the uncoded pixels from the i^{th}−1 DIP coded MB. In step 520, and in accordance with the principles of the invention, adaptive reference picture data, MBᵢ₋₁^{α}, is generated from the i^{th}−1 coded MB, as described above (e.g., see reference processing unit 205 of FIG. 18, Table One of FIG. 12 and Table Two of FIG. 13). It should be recalled that if more than one filter type exists, decoder 450 retrieves the reference list from, e.g., a received slice header, to determine the filter type. In step 530, the MB is decoded in accordance with DIP.

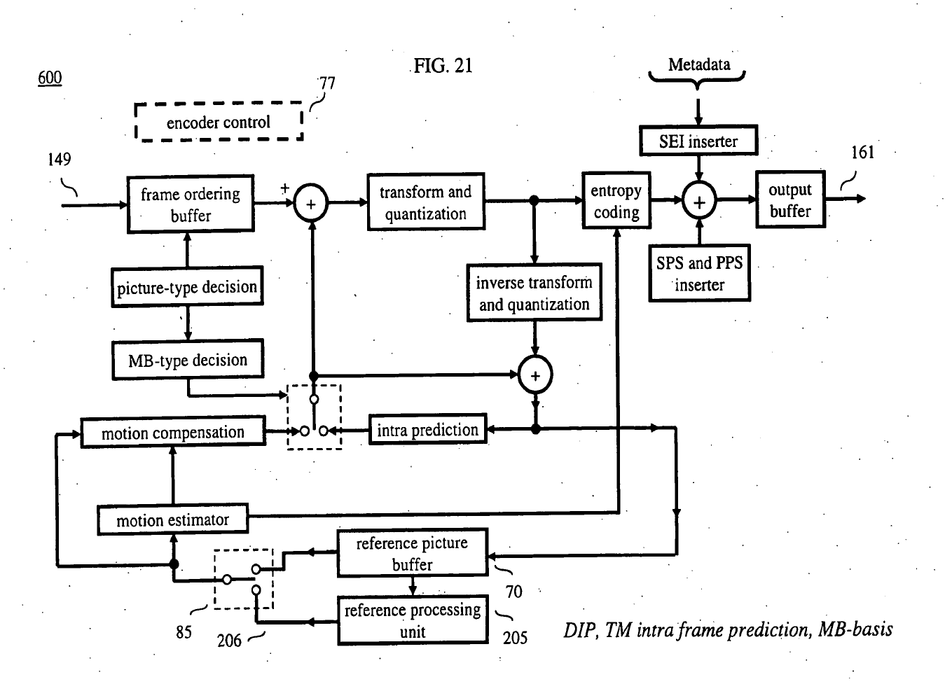

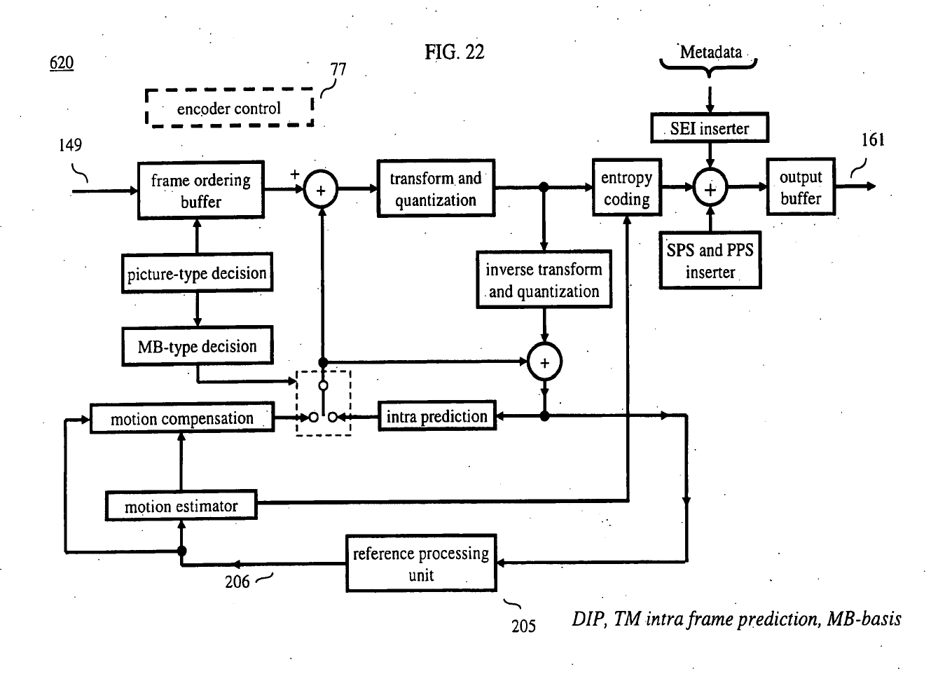

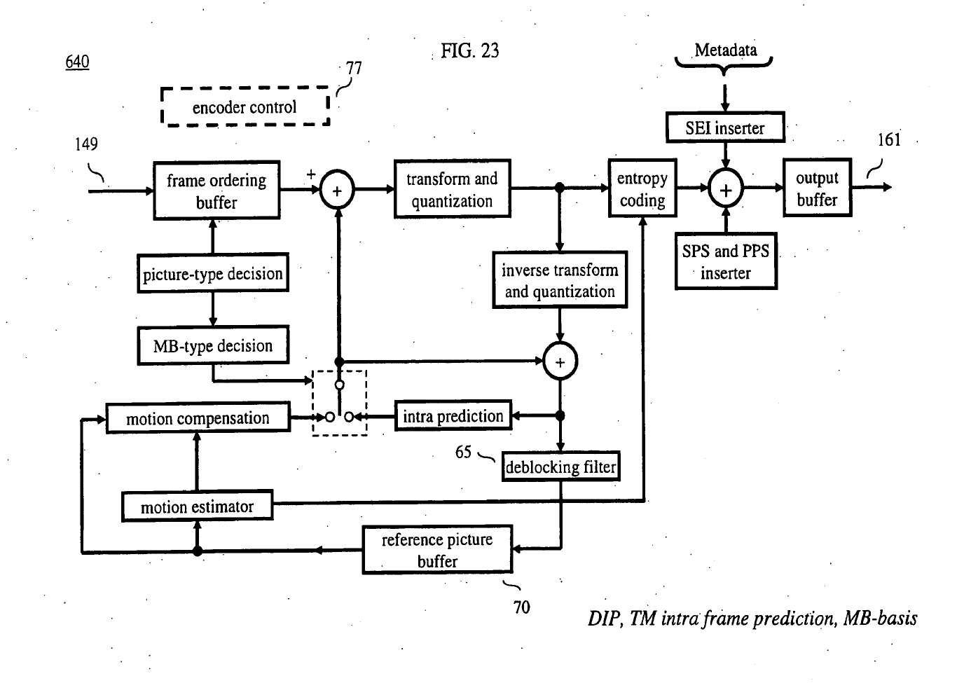

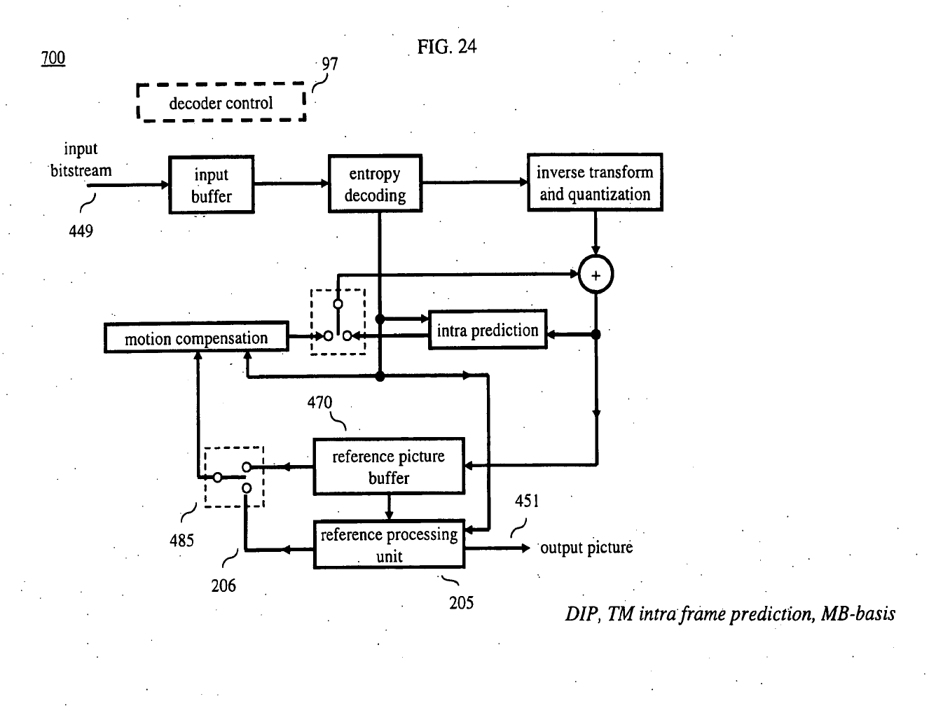

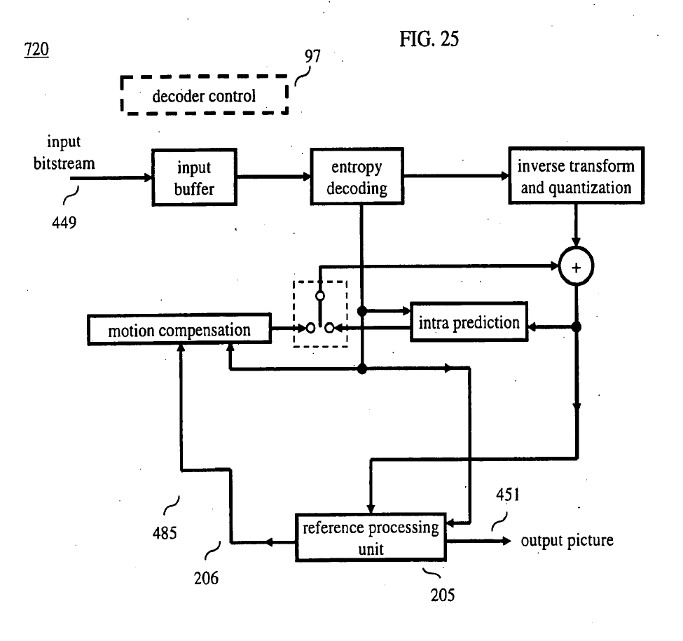

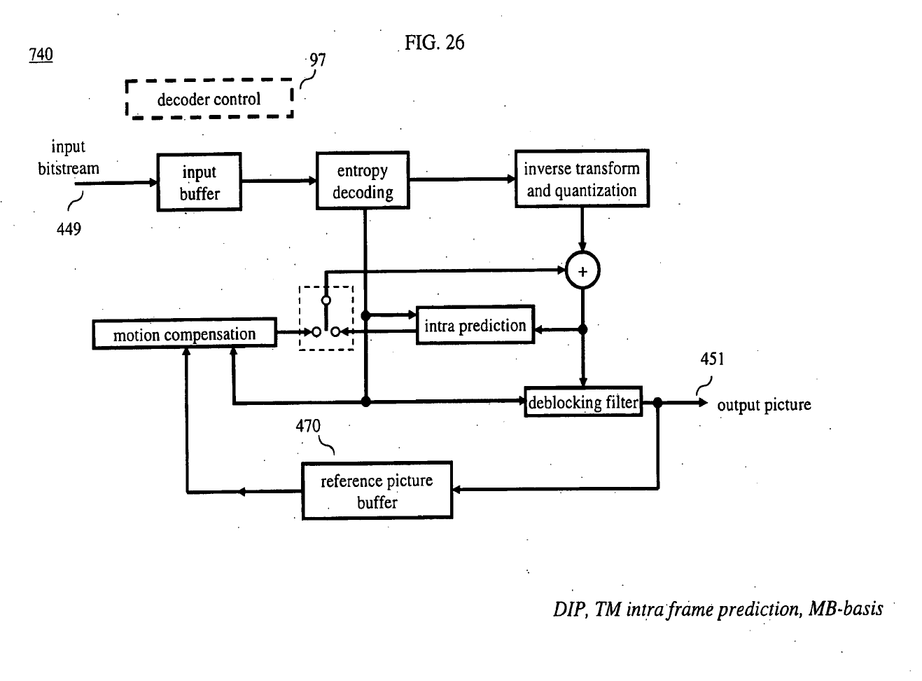

Other illustrative embodiments in accordance with the principles of the invention are shown in FIGS. 21 to 26. FIGS. 21 to 23 show other encoder variations. As can be observed from Table One of FIG. 12, reference processing unit 205 can include a deblocking filter. As such, separate deblocking filter 65 can be removed from the encoder and the deblocking filter of reference processing unit 205 can be used in its place. This variation is shown in encoder 600 of FIG. 21. An additional modification to encoder 600 is shown in encoder 620 of FIG. 22. In this embodiment, reference picture buffer 70 is eliminated and reference processing unit 205 operates in real-time, i.e., on-the-fly. Finally, the embodiment illustrated by encoder 640 of FIG. 23 illustrates use of deblocking filter 65 for all MBs. Typically, as known in the art, deblocking filter 65 is used after a whole slice and/or picture is finished decoding (i.e., on a slice-basis and/or picture-basis not on a MB basis) or on single MB. In contrast, encoder 640 uses the deblocking filter for all MBs. As such, reference processing unit 205 is removed. Turning now to FIGS. 24 to 26, these figures illustrate similar modifications to decoders. For example, decoder 700 of FIG. 24 is similar to encoder 600 of FIG. 21, i.e., the deblocking filter of reference processing unit 205 is used in place of a separate deblocking filter. Decoder 720 of FIG. 25 is similar to encoder 620 of FIG. 22, i.e., reference picture buffer 70 is eliminated and reference processing unit 205 operates in real-time, i.e., on-the-fly. Finally, decoder 740 of FIG. 26 is similar to encoder 640 of FIG. 23, i.e., the deblocking filter is used for all MBs.

As described above, and in accordance with the principles of the invention, adaptive reference picture data is adaptively generated for use in intra prediction. It should be noted that although the inventive concept was illustrated in the context of an DIP and/or TM extension of H.264, the inventive concept is not so limited and is applicable to other types of video encoding.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs). Similarly, although shown as separate elements, any or all of the elements may be implemented in a stored-program-controlled processor, e.g., a digital signal processor, which executes associated software, e.g., corresponding to one or more of the steps shown in, e.g., FIGS. 16 and 20, etc. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for use in video encoding, the method comprising:
generating adaptive reference picture data from previously coded macroblocks of a current picture; and
predicting uncoded macroblocks of the current picture from the adaptive reference picture data.

2. The method of claim 1, wherein the generating step comprises:
using a filter for generating the adaptive reference picture data.

3. The method of claim 1, further comprising the step of:
storing the previously coded macroblocks of the current picture;
wherein the stored previously coded macroblocks of the current picture are for use in the generating step.

4. The method of claim 1, wherein the predicting step further comprises:
performing intra frame prediction coding using the adaptive reference picture data;
wherein the performing step searches previously coded regions of the current picture for predicting a current macroblock.

5. The method of claim 4, wherein the performing step includes the step of:
performing displaced intra prediction on at least some of the current picture.

6. The method of claim 4, wherein the performing step includes the step of:
performing template matching on at least some of the current picture.

7. The method of claim 1, wherein the generating step comprises:
selecting one of a plurality of filter types; and
generating the adaptive reference picture data in accordance with the selected filter type.

8. The method of claim 7, wherein the selected filter type is a deblocking filter.

9. The method of claim 7, wherein the selected filter type operates in the transform domain.

10. The method of claim 7, wherein the selected filter type is a median filter.

11. The method of claim 7, further comprising the step of:
forming a reference list for use by a decoder;
wherein the reference lists identifies selected filter types for use in decoding the current picture being encoded.

12. A computer-readable medium having computer-executable instructions for a processor-based system such that when executed the processor-based system performs a method for video encoding, the method comprising:
generating adaptive reference picture data from previously coded macroblocks of a current picture; and
predicting uncoded macroblocks of the current picture from the adaptive reference picture data.

13. The computer-readable medium of claim 12, wherein the generating step comprises:
using a filter for generating the adaptive reference picture data.

14. The computer-readable medium of claim 12, wherein the method further comprises:
storing the previously coded macroblocks of the current picture;
wherein the stored previously coded macroblocks of the current picture are for use in the generating step.

15. The computer-readable medium of claim 12, wherein the predicting step further comprises:
performing intra frame prediction coding using the adaptive reference picture data;
wherein the performing step searches previously coded regions of the current picture for predicting a current macroblock.

16. The computer-readable medium of claim 15, wherein the performing step includes the step of:
performing displaced intra prediction on at least some of the current picture.

17. The computer-readable medium of claim 15, wherein the performing step includes the step of:
performing template matching on at least some of the current picture.

18. The computer-readable medium of claim 12 wherein the generating step comprises:
selecting one of a plurality of filter types; and
generating the adaptive reference picture data in accordance with the selected filter type.

19. The computer-readable medium of claim 18, wherein the selected filter type is a deblocking filter.

20. The computer-readable medium of claim 18, wherein the selected filter type operates in the transform domain.

21. The computer-readable medium of claim 18, wherein the selected filter type is a median filter.

22. The computer-readable medium of claim 18, wherein the method further comprises:
forming a reference list for use by a decoder;
wherein the reference lists identifies selected filter types for use in decoding the current picture being encoded.

23. Apparatus for use in video encoding, the apparatus comprising:
a buffer for storing previously coded macroblocks of a current picture being encoded; and
a processor for generating adaptive reference picture data from the previously coded macroblocks of the current picture;
wherein the adaptive reference picture data is for use in predicting uncoded macroblocks of the current picture.

24. The apparatus of claim 23, where the processor uses a deblocking filter for generating the adaptive reference picture data.

25. The apparatus of claim 23, wherein the processor performs intra frame prediction coding using the adaptive reference picture data by searching previously coded regions of the current picture for predicting a current macroblock.

26. The apparatus of claim 25, wherein the processor performs displaced intra prediction on at least some of the current picture.

27. The apparatus of claim 25, wherein the processor performs template matching on at least some of the current picture.

28. The apparatus of claim 23, wherein the processor selects one of a plurality of filter types; and generates the adaptive reference picture data in accordance with the selected filter type.

29. The apparatus of claim 28, wherein the selected filter type is a deblocking filter.

30. The apparatus of claim 28, wherein the selected filter type operates in the transform domain.

31. The apparatus of claim 28, wherein the selected filter type is a median filter.

32. The apparatus of claim 28, wherein the processor forms a reference list for use by a decoder;
wherein the reference lists identifies selected filter types for use in decoding the current picture being encoded.

33. The apparatus of claim 23, wherein the apparatus performs video encoding in accordance with H.264 video encoding.

34. A method for use in video decoding, the method comprising:
generating adaptive reference picture data from previously coded macroblocks of a current picture; and
decoding macroblocks of the current picture from the adaptive reference picture data.

35. The method of claim 34, wherein the generating step comprises:
using a filter for generating the adaptive reference picture data.

36. The method of claim 34, further comprising the step of:
storing the previously coded macroblocks of the current picture;
wherein the stored previously coded macroblocks of the current picture are for use in the generating step.

37. The method of claim 34, wherein the decoding step further comprises:
performing intra frame prediction decoding using the adaptive reference picture data;
wherein the performing step searches previously coded regions of the current picture for decoding a current macroblock.

38. The method of claim 37, wherein the performing step includes the step of:
performing displaced intra prediction on at least some of the current picture.

39. The method of claim 37, wherein the performing step includes the step of:
performing template matching on at least some of the current picture.

40. The method of claim 34, wherein the generating step comprises:
receiving a reference list identifying at least one filter type for use in generating the adaptive reference picture data; and
generating the adaptive reference picture data in accordance with the identified filter type.

41. The method of claim 40, wherein the filter type is a deblocking filter.

42. The method of claim 40, wherein the filter type operates in the transform domain.

43. The method of claim 40, wherein the filter type is a median filter.

44. A computer-readable medium having computer-executable instructions for a processor-based system such that when executed the processor-based system performs a method for video decoding, the method comprising:
generating adaptive reference picture data from previously coded macroblocks of a current picture; and
decoding macroblocks of the current picture from the adaptive reference picture data.

45. The computer-readable medium of claim 44, wherein the generating step comprises:
using a filter for generating the adaptive reference picture data.

46. The computer-readable medium of claim 44, wherein the method further comprises:
storing the previously coded macroblocks of the current picture;
wherein the stored previously coded macroblocks of the current picture are for use in the generating step.

47. The computer-readable medium of claim 44, wherein the decoding step further comprises:
performing intra frame prediction decoding using the adaptive reference picture data;
wherein the performing step searches previously coded regions of the current picture for decoding a current macroblock.

48. The computer-readable medium of claim 47, wherein the performing step includes the step of:
performing displaced intra prediction on at least some of the current picture.

49. The computer-readable medium of claim 47, wherein the performing step includes the step of:
performing template matching on at least some of the current picture.

50. The computer-readable medium of claim 44 wherein the generating step comprises:
receiving a reference list identifying at least one filter type for use in generating the adaptive reference picture data; and
generating the adaptive reference picture data in accordance with the identified filter type.

51. The computer-readable medium of claim 50, wherein the filter type is a deblocking filter.

52. The computer-readable medium of claim 50, wherein the filter type operates in the transform domain.

53. The computer-readable medium of claim 50, wherein the filter type is a median filter.

54. Apparatus for use in video decoding, the apparatus comprising:
a buffer for storing previously coded macroblocks of a current picture being decoded; and
a processor for generating adaptive reference picture data from the previously coded macroblocks of the current picture;
wherein the adaptive reference picture data is for use in decoding macroblocks of the current picture.

55. The apparatus of claim 54, where the processor uses a deblocking filter for generating the adaptive reference picture data.

56. The apparatus of claim 54, wherein the processor performs intra frame prediction decoding using the adaptive reference picture data by searching previously coded regions of the current picture for decoding a current macroblock.

57. The apparatus of claim 56, wherein the processor performs displaced intra prediction on at least some of the current picture.

58. The apparatus of claim 56, wherein the processor performs template matching on at least some of the current picture.

59. The apparatus of claim 54, wherein the processor is responsive to a reference list that identifies at least one filter type for use in generating the adaptive reference picture data;
and wherein the processor generates the adaptive reference picture data in accordance with the identified filter type.

60. The apparatus of claim 59, wherein the filter type is a deblocking filter.

61. The apparatus of claim 59, wherein the filter type operates in the transform domain.

62. The apparatus of claim 59, wherein the filter type is a median filter.

63. The apparatus of claim 54, wherein the apparatus performs video decoding in accordance with H.264 video decoding.
